(19) United States
(12) Patent Application Publication
(10) Pub. No.: US 2026/0332854 A1
(43) Pub. Date: Oct. 22, 2026

(54) INFORMATION DISPLAY METHOD, APPARATUS, ELECTRONIC DEVICE, STORAGE MEDIUM, AND PROGRAM PRODUCT

(71) Applicant: Beijing Youzhuju Network Technology Co., Ltd., Beijing (CN)

(72) Inventors: Jia XU, Beijing (CN); Zong WANG, Beijing (CN); Zonglin WEN, Beijing (CN)

(21) Appl. No.: 19/468,944

(22) Filed: Feb. 3, 2026

(30) Foreign Application Priority Data
Feb. 14, 2025 (CN) 202510167904.1

(51) Int. Cl. H04N 21/466; H04N 21/485

(52) U.S. Cl. CPC H04N 21/4668; H04N 21/4852

(57) ABSTRACT

The present disclosure relates to the field of data processing technologies, and discloses an information display method and apparatus, an electronic device, a storage medium, and a program product. The method includes: displaying a video analysis page, where the video analysis page includes an input control; and in response to a video attribute input in the input control, displaying, on the video analysis page, a recommended video corresponding to the video attribute and a target recommendation category of the recommended video, where the recommended video is associated with a demander, and the target recommendation category is determined based on a target playback volume of the recommended video in an unpromoted case and a new addition of a target object of the demander brought by publishing of the recommended video, the target object including an object interested in associated information of the demander.

### CROSS REFERENCE TO RELATED APPLICATIONS

This application is based on and claims priority of CN application with application No. 202510167904.1 filed on Feb. 14, 2025, the entire disclosure of which is hereby incorporated by reference.

### TECHNICAL FIELD

The present disclosure relates to the field of data processing technologies, and in particular, to an information display method and apparatus, an electronic device, a storage medium, and a program product.

### BACKGROUND

With the rapid development of short videos, more and more demanders begin to use videos to show the characteristics of brands or products, so as to enable the public to better understand the brands or products.

### SUMMARY

The present disclosure provides an information display method and apparatus, an electronic device, a storage medium, and a program product.

In a first aspect, the present disclosure provides an information display method, including:
displaying a video analysis page, where the video analysis page includes an input control; and
in response to a video attribute input in the input control, displaying, on the video analysis page, a recommended video corresponding to the video attribute and a target recommendation category of the recommended video, where the recommended video is associated with a demander, and the target recommendation category is determined based on a target playback volume of the recommended video in an unpromoted case and a new addition of a target object of the demander brought by publishing of the recommended video, the target object including an object interested in associated information of the demander.

In a second aspect, the present disclosure provides an information display apparatus, including:
a first display module, configured to display a video analysis page, where the video analysis page includes an input control; and
a second display module, configured to, in response to a video attribute input in the input control, display, on the video analysis page, a recommended video corresponding to the video attribute and a target recommendation category of the recommended video, where the recommended video is associated with a demander, and the target recommendation category is determined based on a target playback volume of the recommended video in an unpromoted case and a new addition of a target object of the demander brought by publishing of the recommended video, the target object including an object interested in associated information of the demander.

In a third aspect, the present disclosure provides an electronic device, including: a memory and a processor, the memory and the processor being communicatively connected to each other, the memory having a computer instruction stored therein, and the processor executing the information display method according to the first aspect or any corresponding implementation thereof by executing the computer instruction.

In a fourth aspect, the present disclosure provides a computer-readable storage medium having a computer instruction stored thereon, the computer instruction being used to cause a computer to execute the information display method according to the first aspect or any corresponding implementation thereof.

In a fifth aspect, the present disclosure provides a computer program product including a computer instruction, the computer instruction being used to cause a computer to execute the information display method according to the first aspect or any corresponding implementation thereof.

According to the information display method provided in the embodiments of the present disclosure, a target recommendation type of a recommended video is displayed while the recommended video is displayed, where the target recommendation type is determined based on a target playback volume of the recommended video in an unpromoted case and a new addition of a target object of a demander brought by publishing of the recommended video.

### BRIEF DESCRIPTION OF THE DRAWINGS

In order to more clearly illustrate the technical solutions in the specific embodiments of the present disclosure or in the related art, the following briefly introduces the drawings required for describing the specific embodiments or the related art. Apparently, the drawings in the following description show some embodiments of the present disclosure, and other drawings may also be obtained by a person of ordinary skill in the art according to these drawings without creative efforts.

FIG. 1 is a schematic flowchart of an information display method according to an embodiment of the present disclosure;

FIG. 2 is a schematic diagram of a video analysis page according to an embodiment of the present disclosure;

FIG. 3 is a schematic flowchart of a method for determining a target recommendation type according to an embodiment of the present disclosure;

FIG. 4 is a schematic flowchart of another information display method according to an embodiment of the present disclosure;

FIG. 5 is a schematic diagram of another video analysis page according to an embodiment of the present disclosure;

FIG. 6 is a block diagram of an information display apparatus according to an embodiment of the present disclosure; and

FIG. 7 is a block diagram of an electronic device according to an embodiment of the present disclosure.

### DETAILED DESCRIPTION OF EMBODIMENTS

In order to make the objectives, technical solutions, and advantages of the embodiments of the present disclosure clearer, the technical solutions in the embodiments of the present disclosure are clearly and completely described below with reference to the drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

It may be understood that before the use of the technical solutions disclosed in the embodiments of the present disclosure, the user shall be informed of the category, range of use, use scenarios, etc., of personal information involved in the present disclosure in an appropriate manner and the authorization of the user shall be obtained in accordance with the relevant laws and regulations.

For example, in response to reception of an active request from a user, prompt information is sent to the user to clearly inform the user that the requested operation will require access to and use of the user’s personal information. In this way, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It may be understood that the above process of notifying the user and obtaining the authorization of the user is only illustrative and does not constitute a limitation on the implementations of the present disclosure, and other manners that satisfy the relevant laws and regulations may also be applied in the implementations of the present disclosure.

It may be understood that the data involved in the technical solutions (including but not limited to the data itself, acquisition or use of the data) shall comply with the requirements of the corresponding laws, regulations, and related provisions.

With the rapid development of short videos, more and more demanders begin to use videos to show the characteristics of brands or products, so as to enable the public to better understand the brands or products. However, in the process of video recommendation, it is often difficult to capture changes in video popularity in a timely manner, thus affecting the effectiveness of video recommendation.

In view of this, according to the embodiments of the present disclosure, an embodiment of an information display method is provided to solve the problem of video recommendation. It should be noted that the steps shown in the flowchart of the drawings may be performed in a computer system such as a set of computer-executable instructions, and although a logical order is shown in the flowchart, in some cases, the steps shown or described may be performed in an order different from that herein.

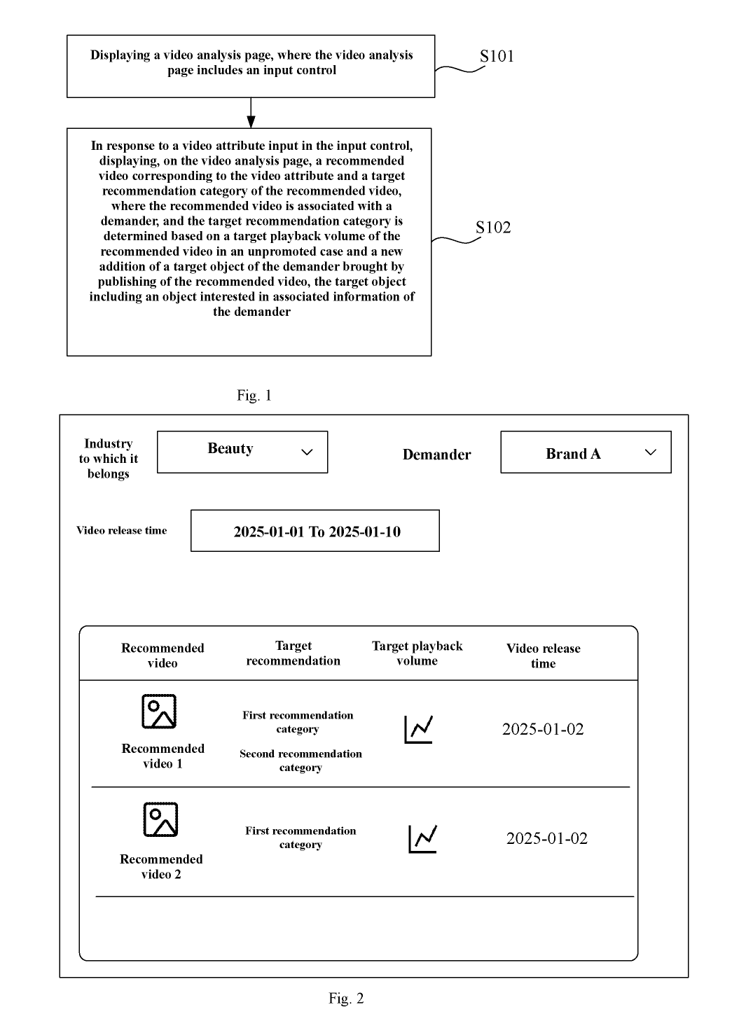

In this embodiment, an information display method is provided, which may be used for an electronic device, such as a computer, a mobile terminal, etc. FIG. 1 is a schematic flowchart of an information display method according to an embodiment of the present disclosure. As shown in FIG. 1, the process includes the following steps.

Step S101: displaying a video analysis page, where the video analysis page includes an input control.

Optionally, the input control includes a sub-control of at least one category attribute. The category attribute includes at least one of a demander of the recommended video or an industry to which the recommended video belongs. In addition, the category attribute may further include a video release time, a video volume, etc., which may be adjusted according to actual situations.

Step S102: in response to a video attribute input in the input control, displaying, on the video analysis page, a recommended video corresponding to the video attribute and a target recommendation category of the recommended video, where the recommended video is associated with a demander, and the target recommendation category is determined based on a target playback volume of the recommended video in an unpromoted case and a new addition of a target object of the demander brought by publishing of the recommended video, the target object including an object interested in associated information of the demander.

Specifically, the video attribute is obtained in response to information input for the input control. Alternatively, at least one optional attribute is displayed (which may be displayed in the form of a drop-down list) in response to an interactive operation on the input control, and the video attribute is determined in response to a selection instruction for the optional attribute. Alternatively, at least one recommended attribute is displayed in a corresponding area of the input control, and the recommended attribute is input in the input control in response to a selection instruction for the recommended attribute, to obtain the video attribute. A method for determining the video attribute is not limited here.

Further, if the input control includes a sub-control of one or more category attributes, the above-mentioned step S102 includes: determining the video attribute in response to information input in a target sub-control, where the target sub-control belongs to the sub-control of the at least one category attribute; and in response to the determined video attribute, displaying, on the video analysis page, the recommended video corresponding to the video attribute and the target recommendation category of the recommended video.

Optionally, the demander is a brand party of the recommended video, or another user who uses the recommended video to show its brand, product, or service.

In a practical application, the associated information of the demander includes a recommended video corresponding to the demander and relevant content other than the recommended video corresponding to the demander, where the relevant content includes text information related to the demander, such as product information, description information of the demander, activity information of the demander, and so on.

It should be noted that, in a practical application, it may be determined whether the recommended video is played in a promoted case or an unpromoted case through a playback channel of the recommended video.

Specifically, a promotion channel is preset, and if the recommended video is played through a non-promotion channel, the playback of the recommended video is recorded as a playback volume in an unpromoted case. If the recommended video is played through the promotion channel, the playback of the recommended video is recorded as a playback volume in a promoted case.

In other words, the target playback volume of the recommended video in the unpromoted case refers to a number of times the recommended video has been played in a case where the recommended video is recommended through a conventional recommendation algorithm. If the recommended video is played through the promotion channel, the playback volume is recorded as the playback volume of the recommended video in the promoted case.

A preset field may be used to record whether each playback of the recommended video belongs to the playback volume in the promoted case or the playback volume in the unpromoted case.

According to the information display method provided in this embodiment, a target recommendation type of a recommended video is displayed while the recommended video is displayed, where the target recommendation type is determined based on a target playback volume of the recommended video in an unpromoted case and a new addition of a target object of a demander brought by publishing of the recommended video. Therefore, in a process of video recommendation, changes in video popularity may be captured by using the target recommendation type, so as to determine a recommendation manner applicable to the recommended video and adjust the recommendation manner of the recommended video in a timely manner, thereby effectively improving the effectiveness of video recommendation.

The beneficial effects of the information display apparatus, the electronic device, the storage medium, and the program product correspond to the beneficial effects of the information display method, and details are not repeated herein.

Exemplarily, as shown in FIG. 2, taking the category attribute including the industry to which the recommended video belongs, the demander of the recommended video, and a video release time of the recommended video as an example, a sub-control of the industry to which the recommended video belongs, a sub-control of the demander, and a sub-control of the video release time are displayed on the video analysis page, and a user may input the industry to which the recommended video belongs in the sub-control of the industry to which the recommended video belongs, input the demander corresponding to the recommended video in the sub-control of the demander, and input the video release time corresponding to the recommended video in the sub-control of the video release time, to obtain the video attribute. For example, if the industry to which the recommended video belongs is "beauty", the demander is "brand A", and the video release time is "2025-01-01 to 2025-01-10", recommended videos published by the brand A in the beauty industry from 2025-01-01 to 2025-01-10, such as recommended video 1 and recommended video 2, are displayed on the video analysis page.

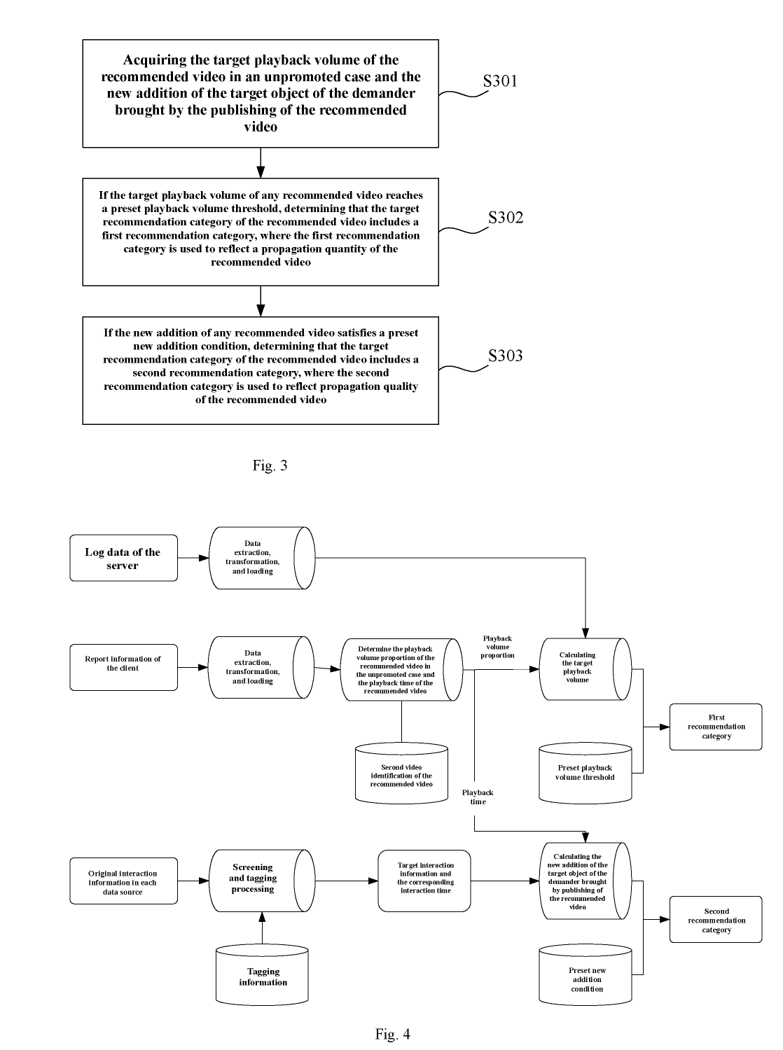

In some optional implementations, as shown in FIG. 3, the information display method of the present disclosure further includes the following steps.

Step S301: acquiring the target playback volume of the recommended video in an unpromoted case and the new addition of the target object of the demander brought by the publishing of the recommended video.

Optionally, log data (counter_log) of the server is accessed, and data extraction, transformation, and loading (ETL) is performed on the log data to obtain the total playback volume of the recommended video. Report information of the client is acquired, and data extraction, transformation, and loading is performed on the report information to obtain the playback volume proportion of the recommended video in the unpromoted case and the promoted case. The target playback volume of the recommended video is determined based on the total playback volume and the playback volume proportion in the unpromoted case. Alternatively, a tracking point for collecting the target playback volume of the recommended video in the unpromoted case is configured on the client to obtain the target playback volume.

Optionally, a number of objects determined as the target objects of the demander on a day when the recommended video is played is recorded to obtain a new addition of the target objects. Based on a ratio of the cumulative new addition of the target objects after the recommended video is published to a number of objects accessing the associated information of the demander after the recommended video is published, the new addition of the target objects of the demander brought by the publishing of the recommended video is obtained, where the new addition is a new addition rate of the target objects after the recommended video is published.

Step S302: determining that the target recommendation category of the recommended video includes a first recommendation category in response to the target playback volume of any recommended video reaching a preset playback volume threshold, the first recommendation category being used to reflect a propagation quantity of the recommended video.

It should be noted that the preset playback volume threshold is related to the industry to which the recommended video belongs. Optionally, the preset playback volume threshold is a first preset proportion of the video playback volume of the industry to which the recommended video belongs. For example, the preset playback volume threshold is 90% of the video playback volume of the industry to which the recommended video belongs.

It may be understood that the greater the propagation quantity, the stronger the propagation capability of the recommended video, and the first recommendation category may represent, to some extent, a situation in which a user is attracted by the recommended video.

Step S303: determining that the target recommendation category of the recommended video includes a second recommendation category in response to the new addition of any recommended video satisfying a preset new addition condition, the second recommendation category being used to reflect propagation quality of the recommended video.

If the new addition is the new addition rate of the target objects, the preset new addition condition is a preset new addition rate threshold. If the new addition rate of any recommended video reaches the preset new addition rate threshold, it is determined that the target recommendation category of the recommended video includes the second recommendation category.

Alternatively, the new addition is represented by a total new addition of the target objects, and the preset new addition condition is a preset total new addition threshold. If the total new addition of any recommended video reaches the preset total new addition threshold, it is determined that the target recommendation category of the recommended video includes the second recommendation category.

It should be noted that the preset new addition rate threshold and the preset total new addition threshold are related to the industry to which the recommended video belongs. Optionally, the preset new addition rate threshold is a second preset proportion of the new addition rate of the target objects corresponding to each video in the industry to which the recommended video belongs. For example, the preset new addition rate threshold is 60% of the new addition rate of the target objects corresponding to each video in the industry to which the recommended video belongs. A method for determining the preset total new addition threshold is similar to the method for determining the preset new addition rate threshold, and details are not repeated herein.

It may be understood that the better the propagation quality, the stronger the promotion effect of the recommended video on the attention to the demander, and the second recommendation category may represent, to some extent, a degree of interest of the user in the demander.

It should be noted that the recommended video has timeliness, and in a practical application, a validity time of the target recommendation category may be preset. The target recommendation category of the recommended video is calculated and displayed only within the validity time. Optionally, the validity time is within a preset time range after the recommended video is published. For example, the validity time is within 3 days after the recommended video is published.

According to the information display method provided in this embodiment, if the target playback volume of any recommended video reaches the preset playback volume threshold, it is determined that the target recommendation category of the recommended video includes the first recommendation category used to reflect the propagation quantity of the recommended video. If the new addition of any recommended video satisfies the preset new addition condition, it is determined that the target recommendation category of the recommended video includes the second recommendation category used to reflect the propagation quality of the recommended video. Therefore, the recommendation effectiveness of the recommended video may be measured comprehensively in two dimensions of the propagation quantity and the propagation quality, so that the target recommendation category may effectively reflect changes in popularity of the recommended video.

In some optional implementations, the step of acquiring the target playback volume of the recommended video in the unpromoted case in step S301 includes the following steps.

Step a1: acquiring the total playback volume of the recommended video from a server.

Specifically, the log data of the server is accessed, and data extraction, transformation, and loading is performed on the log data to obtain the total playback volume of the recommended video (also referred to as exposure data from the perspective of the service port).

Step a2: acquiring the playback volume proportion of the recommended video in the unpromoted case from the client.

Specifically, a tracking point for collecting the playback volume proportion of the played video in the unpromoted case is configured on the client, and the playback volume proportion of the recommended video in the unpromoted case is extracted from the report information of the tracking point on the client.

In a practical application, when the recommended video is played through the non-promotion channel, the first field is used to record that the playback belongs to the playback volume of the recommended video in the non-promoted case. When the recommended video is played through the promotion channel, the second field is used to record that the playback belongs to the playback volume of the recommended video in the promoted case. Statistical analysis is performed on the playback volume of the recommended video in the unpromoted case and the playback volume of the recommended video in the promoted case to obtain the playback volume proportion of the recommended video in the unpromoted case.

Step a3: determining the target playback volume of the recommended video based on the total playback volume and the playback volume proportion of the recommended video.

Specifically, the target playback volume of the recommended video is determined based on a product of the total playback volume and the playback volume proportion.

It should be noted that it is difficult for the server to determine the playback channel of the recommended video distributed to the client, and due to technical limitations and data security considerations, it is often difficult to directly obtain the target playback volume of the recommended video in the unpromoted case from the client in a practical application, and only the playback volume proportion of the recommended video in the unpromoted case may be obtained. Therefore, when acquiring the total playback volume of the recommended video from the server, it is necessary to split the total playback volume of the recommended video distributed by the server in combination with the playback volume proportion of the recommended video in the unpromoted case recorded by the client, to determine the target playback volume of the recommended video.

In some optional implementations, step a2 includes the following steps.

Step a21: acquiring the playback volume proportion of each played video in the client in the unpromoted case and a first video identification of the played video.

Step a22: acquiring a second video identification of the recommended video.

Step a23: determining the playback volume proportion of the recommended video from the playback volume proportion of the played video based on a matching between the first video identification and the second video identification.

The played video includes the recommended video and other videos other than the recommended video.

It should be noted that because the client may be connected to a plurality of data analysis links, it is difficult for the client to ensure that the information of each played video carries the information required by the data analysis links. Therefore, the report information of the client often only carries the original first video identification of the played video. According to the information display method of the present disclosure, the playback volume proportion of the recommended video is determined from the playback volume proportion of the played video by combining the second video identification and the first video identification of the recommended video.

In some optional implementations, the step of acquiring the new addition of the target object of the demander brought by the publishing of the recommended video in the above-mentioned step S301 includes the following steps.

Step b1: acquiring operation information of at least one candidate object, where the operation information includes a playback time of the candidate object for the recommended video, target interaction information of the candidate object for the associated information, and an interaction time corresponding to the target interaction information.

The candidate object includes a user who plays the recommended video in each video application.

Optionally, the playback time of the candidate object for the recommended video is acquired from the client.

Optionally, the target interaction information includes interaction information such as a viewing duration, an interaction type, and an interaction frequency of the candidate object for the associated information, where the interaction frequency includes a like frequency, a comment frequency, a sharing frequency, and so on. In a practical application, the target interaction information may be adjusted according to actual situations.

Step b2: determining a new target object of the demander from the at least one candidate object based on a degree of interest of the candidate object in the associated information represented by the target interaction information.

Specifically, a target object determination condition may be configured in advance, and if the target interaction information of any candidate object satisfies the target object determination condition, the candidate object is determined to be the new target object of the demander. For example, if the viewing duration of the candidate object for the recommended video is greater than 2 minutes, the candidate object follows the demander, and the candidate object comments on or recommends the associated information of the demander, the candidate object is determined to be the new target object.

Step b3: performing statistical analysis on the new target object related to the recommended video based on the matching between the playback time and the interaction time to obtain the new addition.

Specifically, if the playback time of the recommended video matches the interaction time, the new target object determined under the target interaction information at the interaction time is determined to be the new target object related to the recommended video.

For example, the new target object determined on the day when the recommended video is played is determined to be the new target object related to the recommended video.

According to the information display method provided in this embodiment, after the new target object is determined based on the target interaction information of the candidate object, the new target object related to the recommended video is determined based on the matching between the playback time of the recommended video and the interaction time of the target interaction information. Therefore, the new target object brought by the exposure of the recommended video may be effectively determined, thereby accurately analyzing the new addition of the target object of the demander brought by the publishing of the recommended video.

In some optional implementations, the step of acquiring the target interaction information in step b1 includes the following steps.

Step b11: acquiring tagging information of the demander.

The tagging information includes description information of the demander in a plurality of dimensions, such as a name, a category, a style, a summary, and an industry to which the demander belongs. In addition, the tagging information further includes description information of the industry to which the recommended video corresponding to the demander belongs.

It should be noted that the tagging information should include the above category attribute, so as to facilitate the selection of the recommended video to be displayed on the video analysis page.

Step b12: screening original interaction information in a data source of the associated information based on the tagging information to obtain screened interaction information.

Specifically, the data source of the associated information includes each data source that records the interaction information for the associated information. Taking the recommended video as an example, the data source of the recommended video includes a release platform of the recommended video, a video application that plays the recommended video, and so on.

It may be understood that the data source includes the original interaction information of various types of information, and it is difficult to determine which original interaction information is generated by the candidate object for the associated information of the demander. Therefore, it is necessary to screen the original interaction information based on the tagging information, to determine the interaction information generated by the candidate object for the associated information of the demander (that is, the above screened interaction information).

Step b13: tagging the screened interaction information based on the tagging information to obtain the target interaction information.

Specifically, the demander corresponding to the screened interaction information is tagged based on the tagging information to obtain the target interaction information.

In addition, the industry corresponding to the screened interaction information may also be tagged based on the tagging information, which may be selected according to actual requirements and is not limited here.

According to the information display method provided in this embodiment, the original interaction information in the data source of the associated information is screened and tagged based on the tagging information of the demander to obtain the target interaction information. Therefore, the accuracy of the target interaction information may be ensured.

In some optional implementations, the above-mentioned step b3 includes the following steps.

Step b31: acquiring the number of accessing objects of the associated information after the recommended video is published.

Specifically, the number of accessing objects includes the number of unique visitors (UVs) of the associated information after the recommended video is published.

Step b32: performing statistical analysis on the new target object related to the recommended video based on the matching between the playback time and the interaction time to obtain a total new addition of the target objects brought by the publishing of the recommended video.

Specifically, the new target object on the day when the recommended video is played is counted based on the matching between the playback time and the interaction time. The new target object every day after the recommended video is published is accumulated to obtain the total new addition of the target objects.

Step b33: obtaining the new addition based on a ratio of the total new addition of the target objects to the number of accessing objects.

According to the information display method provided in this embodiment, the new addition of the target object of the demander brought by the publishing of the recommended video is determined based on the ratio of the total new addition of the target objects brought by the publishing of the recommended video to the number of accessing objects of the associated information after the recommended video is published, so that the new addition may effectively reflect a change trend of the target object of the demander after the recommended video is published, and the target recommendation category determined based on the new addition may better reflect the changes in popularity of the recommended video.

In some optional implementations, the above-mentioned step b33 includes the following steps.

Step b331: performing attribution analysis on the total new addition of the target objects to obtain a first new addition of the target objects in the case where the recommended video is not promoted and a second new addition of the target objects in the case where the recommended video is promoted.

Step b332: obtaining a first new addition of the target object in the case where the recommended video is not promoted based on a ratio of the first new addition of the target objects to the number of accessing objects.

Step b333: obtaining a second new addition of the target object in the case where the recommended video is promoted based on a ratio of the second new addition of the target objects to the number of accessing objects.

Specifically, the attribution analysis is performed on the total new addition of the target objects based on a probability attribution manner, to obtain the first new addition of the target objects and the second new addition of the target objects.

In a practical application, when recording the playback time of the recommended video, the client synchronously records the playback channel (such as the promotion channel and the non-promotion channel) of the recommended video, thereby recording the playback time of the recommended video in the case where the recommended video is not promoted and the playback time of the recommended video in the case where the recommended video is promoted. It is convenient to determine the new target object in the case where the recommended video is not promoted and the new target object in the case where the recommended video is promoted based on the matching between the playback time and the interaction time, for performing the attribution analysis on the total new addition of the target objects.

According to the information display method provided in this embodiment, the new addition of the target objects in the case where the recommended video is not promoted and the new addition of the target objects in the case where the recommended video is promoted are determined separately by performing the attribution analysis on the total new addition of the target objects. Therefore, real-time conversion attribution may be performed on the new target object, thereby deeply analyzing the reason for the new addition of the target object of the demander.

In some optional implementations, the information display method of the present disclosure further includes: displaying the first new addition and the second new addition on the video analysis page.

As a specific embodiment, as shown in FIG. 4, the main steps of the information display method of the present disclosure include: accessing log data of the server, and performing data extraction, transformation, and loading on the log data to obtain the total playback volume of the recommended video; acquiring the report information of the client, and performing data extraction, transformation, and loading on the report information to obtain the playback volume proportion of the played video in the unpromoted case and the first video identification of the played video; determining the playback volume proportion of the recommended video in the unpromoted case from the playback volume proportion corresponding to the played video based on the matching between the second video identification and the first video identification of the recommended video, and determining the playback time of the recommended video; calculating the target playback volume of the recommended video in the unpromoted case based on the total playback volume of the recommended video and the playback volume proportion of the recommended video in the unpromoted case; if the target playback volume of any recommended video reaches the preset playback volume threshold, determining that the target recommendation category of the recommended video includes the first recommendation category; acquiring the original interaction information in the data source of the associated information of the demander; screening and tagging the original interaction information based on the tagging information of the demander to obtain the target interaction information and the corresponding interaction time; calculating the new addition of the target object of the demander brought by the publishing of the recommended video based on the playback time of the recommended video, the target interaction information, and the interaction time of the target interaction information; and if the new addition of any recommended video satisfies the preset new addition condition, determining that the target recommendation category of the recommended video includes the second recommendation category.

In some optional implementations, as shown in FIG. 5, the information display method of the present disclosure further includes: generating a video recommendation suggestion based on the target recommendation category of the recommended video; and displaying the video recommendation suggestion on the video analysis page.

According to the information display method provided in this embodiment, the video recommendation suggestion is generated and displayed based on the target recommendation category of the recommended video. Therefore, the recommendation of the recommended video may be guided by the video recommendation suggestion, to improve the recommendation effectiveness of the recommended video.

In some optional implementations, the information display method of the present disclosure further includes: counting the number of recommended videos in the first recommendation category and/or the second recommendation category, and displaying a counting result on the video analysis page.

In some optional implementations, the information display method of the present disclosure further includes: displaying the target playback volume of the recommended video on the video analysis page. In addition, information such as a video release time of the recommended video may also be displayed.

Exemplarily, referring to FIG. 5, taking the recommended video including recommended video 1 and recommended video 2 as an example, the recommended video 1, a target recommendation category (such as the first recommendation category and the second recommendation category) of the recommended video 1, a target playback volume of the recommended video 1, and a video release time (such as 2025-01-02) of the recommended video 1 may be displayed on the video analysis page. In addition, the recommended video 2, a target recommendation category (such as the first recommendation category) of the recommended video 2, a target playback volume of the recommended video 2, and a video release time (such as 2025-01-02) of the recommended video 2 are displayed. Meanwhile, based on the target recommendation category of the recommended video 1 and the target recommendation category of the recommended video 2, the corresponding video recommendation suggestion is displayed on the video analysis page.

In some optional implementations, at least one recommendation category is displayed in a target area of the video analysis page. The information display method of the present disclosure further includes: in response to a selection instruction for the at least one recommendation category, displaying, on the data analysis page, a recommended video corresponding to a selected recommendation category.

As a specific application example, a target application is installed on the electronic device, and the target application is configured to perform the information display method of the present disclosure. The video analysis page is displayed in the target application, and the user may input the video attribute of the recommended video to be viewed through the video analysis page. The target application displays the recommended video corresponding to the video attribute and the target recommendation category of the recommended video in response to the input video attribute, to disclose the changes in popularity of the recommended video in real time by using the target recommendation category, so that the user determines the recommendation manner of the recommended video in a subsequent process based on the displayed target recommendation category.

In this embodiment, an information display apparatus is further provided. The apparatus is configured to implement the above embodiments and preferred implementations, which have been described and will not be repeated here. As used below, the term "module" may implement a combination of software and/or hardware for a predetermined function. Although the apparatus described in the following embodiments is preferably implemented in software, implementation in hardware, or a combination of software and hardware is also possible and contemplated.

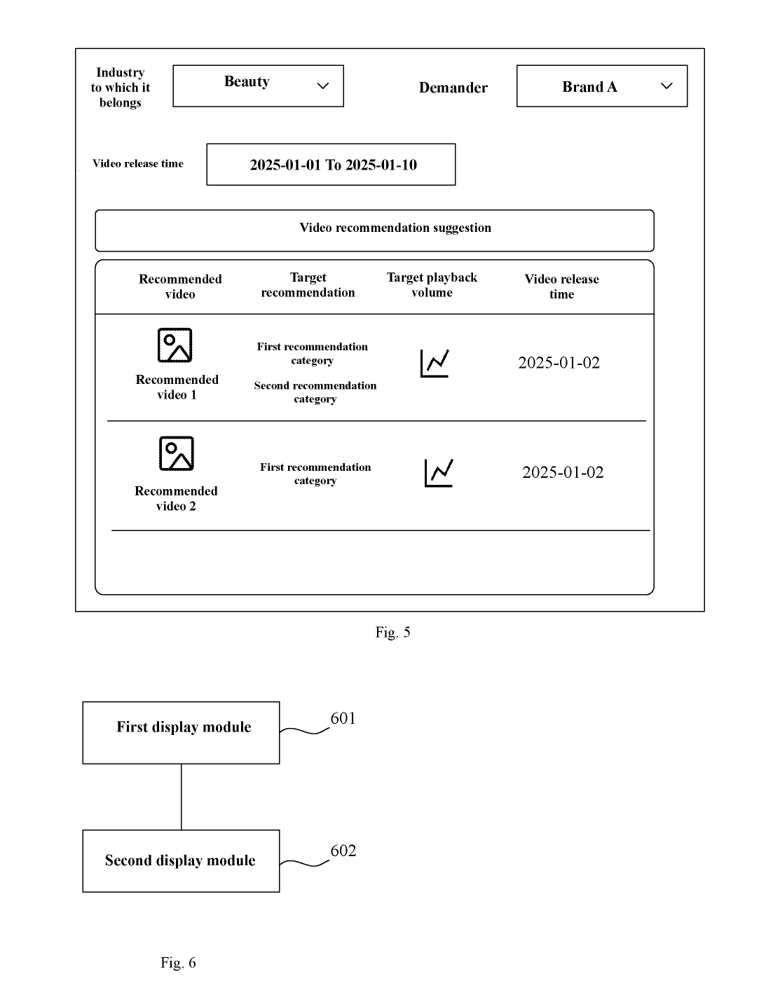

This embodiment provides an information display apparatus, as shown in FIG. 6, including:
a first display module 601, configured to display a video analysis page, where the video analysis page includes an input control; and
a second display module 602, configured to, in response to a video attribute input in the input control, display, on the video analysis page, a recommended video corresponding to the video attribute and a target recommendation category of the recommended video, where the recommended video is associated with a demander, and the target recommendation category is determined based on a target playback volume of the recommended video in an unpromoted case and a new addition of a target object of the demander brought by publishing of the recommended video, the target object including an object interested in associated information of the demander.

In some optional implementations, the information display apparatus of the present disclosure further includes:
a data acquisition module, configured to acquire the target playback volume of the recommended video in the unpromoted case and the new addition of the target object of the demander brought by the publishing of the recommended video;
a first analysis module, configured to, if the target playback volume of any recommended video reaches a preset playback volume threshold, determine that the target recommendation category of the recommended video includes a first recommendation category, the first recommendation category being used to reflect a propagation quantity of the recommended video; and
a second analysis module, configured to, if the new addition of any recommended video satisfies a preset new addition condition, determine that the target recommendation category of the recommended video includes a second recommendation category, the second recommendation category being used to reflect a propagation quality of the recommended video.

In some optional implementations, the data acquisition module includes:
a first acquisition unit, configured to acquire a total playback volume of the recommended video from a server;
a second acquisition unit, configured to acquire a playback volume proportion of the recommended video in the unpromoted case from a client; and
a first operation unit, configured to determine the target playback volume of the recommended video based on the total playback volume and the playback volume proportion of the recommended video.

In some optional implementations, the second acquisition unit includes: '
a first acquisition subunit, configured to acquire a playback volume proportion of each played video in the client in the unpromoted case and a first video identification of the played video;
a second acquisition subunit, configured to acquire a second video identification of the recommended video; and
a proportion operation subunit, configured to determine the playback volume proportion of the recommended video from the playback volume proportion of the played video based on a matching between the first video identification and the second video identification.

In some optional implementations, the data acquisition module further includes:
a third acquisition unit, configured to acquire operation information of at least one candidate object, where the operation information includes a playback time of the candidate object for the recommended video, target interaction information of the candidate object for the associated information, and an interaction time corresponding to the target interaction information;
a second operation unit, configured to determine a new target object of the demander from the at least one candidate object based on a degree of interest of the candidate object in the associated information represented by the target interaction information; and
a statistical analysis unit, configured to perform statistical analysis on the new target object related to the recommended video based on the matching between the playback time and the interaction time to obtain the new addition.

In some optional implementations, the third acquisition unit includes:
a tagging information acquisition subunit, configured to acquire tagging information of the demander;
an information screening subunit, configured to screen original interaction information in a data source of the associated information based on the tagging information to obtain screened interaction information; and
an information tagging subunit, configured to tag the screened interaction information based on the tagging information to obtain the target interaction information.

In some optional implementations, the statistical analysis unit includes:
an access number acquisition subunit, configured to acquire the number of accessing objects of the associated information after the recommended video is published;
a statistical analysis subunit, configured to perform statistical analysis on the new target object related to the recommended video based on the matching between the playback time and the interaction time to obtain a total new addition of the target objects brought by the publishing of the recommended video; and
a new addition operation subunit, configured to obtain the new addition based on a ratio of the total new addition of the target objects to the number of accessing objects.

In some optional implementations, the new addition operation subunit is further configured to: perform attribution analysis on the total new addition of the target objects to obtain a first new addition of the target objects in the case where the recommended video is not promoted and a second new addition of the target objects in the case where the recommended video is promoted; obtain a first new addition of the target object in the case where the recommended video is not promoted based on a ratio of the first new addition of the target objects to the number of accessing objects; and obtain a second new addition of the target object in the case where the recommended video is promoted based on a ratio of the second new addition of the target objects to the number of accessing objects.

In some optional implementations, the information display apparatus of the present disclosure further includes:
a suggestion generation module, configured to generate a video recommendation suggestion based on the target recommendation category of the recommended video; and
a third display module, configured to display the video recommendation suggestion on the video analysis page.

Further functional descriptions of the above modules and units are the same as the corresponding embodiments above, and are not repeated here.

The information display apparatus in this embodiment is presented in the form of a functional unit, and the unit here refers to an ASIC (Application Specific Integrated Circuit) circuit, a processor and a memory that execute one or more software or fixed programs, and/or other devices that may provide the above functions.

An embodiment of the present disclosure further provides an electronic device having the information display apparatus shown in FIG. 6.

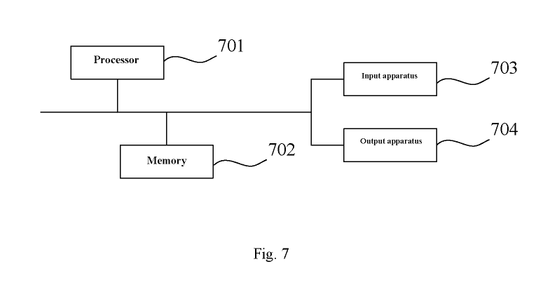

Please refer to FIG. 7. FIG. 7 is a block diagram of an electronic device according to an optional embodiment of the present disclosure. As shown in FIG. 7, the electronic device includes: one or more processors 701, a memory 702, and interfaces for connecting various components, including high-speed interfaces and low-speed interfaces. The components communicate with each other using different buses and may be installed on a common main board or in other manners as needed. The processor may process instructions executed within the electronic device, including instructions stored in or on the memory to display graphical information of GUI on an external input/output apparatus (such as a display device coupled to the interface). In some optional implementations, if required, multiple processors and/or buses may be used with multiple memories. Similarly, multiple electronic devices may be connected, and each device provides some necessary operations (for example, as a server array, a group of blade servers, or a multi-processor system). In FIG. 7, one processor 701 is taken as an example.

The processor 701 may be a central processing unit, a network processor, or a combination thereof. The processor 701 may further include a hardware chip. The hardware chip may be an application specific integrated circuit, a programmable logic device, or a combination thereof. The programmable logic device may be a complex programmable logic device, a field programmable logic gate array, a generic array logic, or any combination thereof.

The memory 702 has instructions executable by at least one processor 701 stored thereon, to cause the at least one processor 701 to perform the method shown in the above embodiments.

The memory 702 may include a program storage area and a data storage area, where the program storage area may store an application required by an operating system and at least one function; the data storage area may store data created according to the use of the electronic device, and so on. In addition, the memory 702 may include a high-speed random access memory or a non-transitory memory, such as at least one magnetic disk storage device, a flash memory device, or other non-transitory solid-state storage devices. In some optional implementations, the memory 702 optionally includes memories remotely provided with respect to the processor 701, and these remote memories may be connected to the electronic device through a network. Examples of the above network include, but are not limited to, Internet, an intranet, a local area network, a mobile communication network, and a combination thereof.

The memory 702 may include a volatile memory, such as a random access memory; the memory may also include a non-volatile memory, such as a flash memory, a hard disk, or a solid-state disk; the memory 702 may further include a combination of the above kinds of memories.

The electronic device further includes an input apparatus 703 and an output apparatus 704. The processor 701, the memory 702, the input apparatus 703, and the output apparatus 704 may be connected through a bus or in other manners. In FIG. 7, connection through a bus is used as an example.

The input apparatus 703 may receive input digital or character information, and generate a key signal input related to user settings and function control of the electronic device, such as a touch screen, a keypad, a mouse, a track pad, a touch panel, an indicator stick, one or more mouse buttons, a trackball, a joystick, and so on. The output apparatus 704 may include a display device, an auxiliary lighting apparatus (such as an LED), a tactile feedback apparatus (such as a vibration motor), and so on. The above display device includes, but is not limited to, a liquid crystal display, a light emitting diode, a display, and a plasma display. In some optional implementations, the display device may be a touch screen.

An embodiment of the present disclosure further provides a computer-readable storage medium. The method according to the embodiments of the present disclosure may be implemented in hardware or firmware, or implemented as computer codes that may be recorded on a storage medium or originally stored in a remote storage medium or a non-transitory machine-readable storage medium and downloaded through a network and to be stored in a local storage medium. Thus, the method described herein may be processed by such software stored on the storage medium using a general-purpose computer, a dedicated processor, or programmable or dedicated hardware. The storage medium may be a magnetic disk, an optical disc, a read-only memory, a random access memory, a flash memory, a hard disk, or a solid-state disk, and so on. Further, the storage medium may further include a combination of the above kinds of memories. It may be understood that the computer, the processor, the microprocessor controller or the programmable hardware includes a storage component that may store or receive software or computer codes, and when the software or computer codes are accessed and executed by the computer, the processor or the hardware, the method shown in the above embodiments is implemented.

A portion of the present disclosure may be applied as a computer program product, such as computer program instructions, which, when executed by a computer, may invoke or provide the method and/or technical solutions according to the present disclosure through the operation of the computer. A person skilled in the art should understand that the computer program instructions may be stored in a computer-readable medium in a form including, but not limited to, a source file, an executable file, an installation package file, etc. Accordingly, the computer program instructions may be executed by the computer in a manner including, but not limited to, the computer directly executing the instructions, or the computer compiling the instructions and then executing the corresponding compiled program, or the computer reading and executing the instructions, or the computer reading and installing the instructions and then executing the corresponding installed program. Here, the computer-readable medium may be any available computer-readable storage medium or communication medium accessible by the computer.

Although the embodiments of the present disclosure are described with reference to the drawings, a person skilled in the art may make various modifications and variations without departing from the spirit and scope of the present disclosure, and such modifications and variations fall within the scope defined by the appended claims.

1. An information display method, comprising:
displaying a video analysis page, wherein the video analysis page comprises an input control; and
in response to a video attribute input in the input control, displaying, on the video analysis page, a recommended video corresponding to the video attribute and a target recommendation category of the recommended video, wherein the recommended video is associated with a demander, and the target recommendation category is determined based on a target playback volume of the recommended video in an unpromoted case and a new addition of a target object of the demander brought by publishing of the recommended video, the target object comprising an object interested in associated information of the demander.

2. The information display method of claim 1, further comprising:
acquiring the target playback volume of the recommended video in the unpromoted case and the new addition of the target object of the demander brought by the publishing of the recommended video;
in response to the target playback volume of any of the recommended video reaching a preset playback volume threshold, determining that the target recommendation category of the recommended video comprises a first recommendation category, wherein the first recommendation category is used to reflect a propagation quantity of the recommended video; and
in response to the new addition of any of the recommended video satisfying a preset new addition condition, determining that the target recommendation category of the recommended video comprises a second recommendation category, wherein the second recommendation category is used to reflect a propagation quality of the recommended video.

3. The information display method of claim 2, wherein the acquiring the target playback volume of the recommended video in the unpromoted case comprises:
acquiring a total playback volume of the recommended video from a server;
acquiring a playback volume proportion of the recommended video in the unpromoted case from a client; and
determining the target playback volume of the recommended video based on the total playback volume and the playback volume proportion of the recommended video.

4. The information display method of claim 3, wherein the acquiring the playback volume proportion of the recommended video in the unpromoted case from the client comprises:
acquiring a playback volume proportion of each played video in the client in the unpromoted case and a first video identification of the played video;
acquiring a second video identification of the recommended video; and
based on a matching between the first video identification and the second video identification, determining the playback volume proportion of the recommended video from the playback volume proportion of the played video.

5. The information display method of claim 2, wherein the acquiring the new addition of the target object of the demander brought by the publishing of the recommended video comprises:
acquiring operation information of at least one candidate object, wherein the operation information comprises a playback time of the candidate object for the recommended video, target interaction information of the candidate object for the associated information, and an interaction time corresponding to the target interaction information;
based on a degree of interest of the candidate object in the associated information represented by the target interaction information, determining a new target object of the demander from the at least one candidate object; and
performing statistical analysis on new target objects related to the recommended video based on a matching between the playback time and the interaction time to obtain the new addition.

6. The information display method of claim 5, wherein the performing statistical analysis on the new target objects related to the recommended video based on the matching between the playback time and the interaction time to obtain the new addition comprises:
acquiring a number of accessing objects of the associated information after the recommended video is published;
performing statistical analysis on the new target objects related to the recommended video based on the matching between the playback time and the interaction time to obtain a total new addition of the target objects brought by the publishing of the recommended video; and
obtaining the new addition based on a ratio of the total new addition of the target objects to the number of accessing objects.

7. The information display method of claim 6, wherein the obtaining the new addition based on the ratio of the total new addition of the target objects to the number of accessing objects comprises:
performing attribution analysis on the total new addition of the target objects to obtain a first new addition of the target objects in a case wherein the recommended video is not promoted and a second new addition of the target objects in a case wherein the recommended video is promoted;
obtaining, based on a ratio of the first new addition of the target objects to the number of accessing objects, a first new addition of the target object in the case wherein the recommended video is not promoted; and
obtaining, based on a ratio of the second new addition of the target objects to the number of accessing objects, a second new addition of the target object in the case wherein the recommended video is promoted.

8. The information display method of claim 5, wherein the acquiring the target interaction information comprises:
acquiring tagging information of the demander;
screening, based on the tagging information, original interaction information in a data source of the associated information to obtain screened interaction information; and
tagging the screened interaction information based on the tagging information to obtain the target interaction information.

9. The information display method of claim 1, further comprising:
generating a video recommendation suggestion based on the target recommendation category of the recommended video; and
displaying the video recommendation suggestion on the video analysis page.

10. An electronic device, comprising:
a memory and a processor, wherein the memory and the processor are communicatively connected to each other, the memory has computer instructions stored therein, and the processor executes an information display method comprising:
displaying a video analysis page, wherein the video analysis page comprises an input control; and
in response to a video attribute input in the input control, displaying, on the video analysis page, a recommended video corresponding to the video attribute and a target recommendation category of the recommended video, wherein the recommended video is associated with a demander, and the target recommendation category is determined based on a target playback volume of the recommended video in an unpromoted case and a new addition of a target object of the demander brought by publishing of the recommended video, the target object comprising an object interested in associated information of the demander.

11. The electronic device of claim 10, further comprising:
acquiring the target playback volume of the recommended video in the unpromoted case and the new addition of the target object of the demander brought by the publishing of the recommended video;
in response to the target playback volume of any of the recommended video reaching a preset playback volume threshold, determining that the target recommendation category of the recommended video comprises a first recommendation category, wherein the first recommendation category is used to reflect a propagation quantity of the recommended video; and
in response to the new addition of any of the recommended video satisfying a preset new addition condition, determining that the target recommendation category of the recommended video comprises a second recommendation category, wherein the second recommendation category is used to reflect a propagation quality of the recommended video.

12. The electronic device of claim 11, wherein the acquiring the target playback volume of the recommended video in the unpromoted case comprises:
acquiring a total playback volume of the recommended video from a server;
acquiring a playback volume proportion of the recommended video in the unpromoted case from a client; and
determining the target playback volume of the recommended video based on the total playback volume and the playback volume proportion of the recommended video.

13. The electronic device of claim 12, wherein the acquiring the playback volume proportion of the recommended video in the unpromoted case from the client comprises:
acquiring a playback volume proportion of each played video in the client in the unpromoted case and a first video identification of the played video;
acquiring a second video identification of the recommended video; and
based on a matching between the first video identification and the second video identification, determining the playback volume proportion of the recommended video from the playback volume proportion of the played video.

14. The electronic device of claim 11, wherein the acquiring the new addition of the target object of the demander brought by the publishing of the recommended video comprises:
acquiring operation information of at least one candidate object, wherein the operation information comprises a playback time of the candidate object for the recommended video, target interaction information of the candidate object for the associated information, and an interaction time corresponding to the target interaction information;
based on a degree of interest of the candidate object in the associated information represented by the target interaction information, determining a new target object of the demander from the at least one candidate object; and
performing statistical analysis on new target objects related to the recommended video based on a matching between the playback time and the interaction time to obtain the new addition.

15. The electronic device of claim 14, wherein the performing statistical analysis on the new target objects related to the recommended video based on the matching between the playback time and the interaction time to obtain the new addition comprises:
acquiring a number of accessing objects of the associated information after the recommended video is published;
performing statistical analysis on the new target objects related to the recommended video based on the matching between the playback time and the interaction time to obtain a total new addition of the target objects brought by the publishing of the recommended video; and
obtaining the new addition based on a ratio of the total new addition of the target objects to the number of accessing objects.

16. A non-transitory computer-readable storage medium having computer instructions stored thereon, wherein the computer instructions are used to cause a computer to execute an information display method comprising:
displaying a video analysis page, wherein the video analysis page comprises an input control; and
in response to a video attribute input in the input control, displaying, on the video analysis page, a recommended video corresponding to the video attribute and a target recommendation category of the recommended video, wherein the recommended video is associated with a demander, and the target recommendation category is determined based on a target playback volume of the recommended video in an unpromoted case and a new addition of a target object of the demander brought by publishing of the recommended video, the target object comprising an object interested in associated information of the demander.

17. The non-transitory computer-readable storage medium of claim 16, further comprising:
acquiring the target playback volume of the recommended video in the unpromoted case and the new addition of the target object of the demander brought by the publishing of the recommended video;
in response to the target playback volume of any of the recommended video reaching a preset playback volume threshold, determining that the target recommendation category of the recommended video comprises a first recommendation category, wherein the first recommendation category is used to reflect a propagation quantity of the recommended video; and
in response to the new addition of any of the recommended video satisfying a preset new addition condition, determining that the target recommendation category of the recommended video comprises a second recommendation category, wherein the second recommendation category is used to reflect a propagation quality of the recommended video.

18. The non-transitory computer-readable storage medium of claim 17, wherein the acquiring the target playback volume of the recommended video in the unpromoted case comprises:
acquiring a total playback volume of the recommended video from a server;
acquiring a playback volume proportion of the recommended video in the unpromoted case from a client; and
determining the target playback volume of the recommended video based on the total playback volume and the playback volume proportion of the recommended video.

19. The non-transitory computer-readable storage medium of claim 18, wherein the acquiring the playback volume proportion of the recommended video in the unpromoted case from the client comprises:
acquiring a playback volume proportion of each played video in the client in the unpromoted case and a first video identification of the played video;
acquiring a second video identification of the recommended video; and
based on a matching between the first video identification and the second video identification, determining the playback volume proportion of the recommended video from the playback volume proportion of the played video.

20. The non-transitory computer-readable storage medium of claim 17, wherein the acquiring the new addition of the target object of the demander brought by the publishing of the recommended video comprises:
acquiring operation information of at least one candidate object, wherein the operation information comprises a playback time of the candidate object for the recommended video, target interaction information of the candidate object for the associated information, and an interaction time corresponding to the target interaction information;
based on a degree of interest of the candidate object in the associated information represented by the target interaction information, determining a new target object of the demander from the at least one candidate object; and
performing statistical analysis on new target objects related to the recommended video based on a matching between the playback time and the interaction time to obtain the new addition.
